(19) United States
(12) Patent Application Publication
(10) Pub. No.: US 2026/0302292 A1
(43) Pub. Date: Oct. 1, 2026

(54) CENTRALIZED HYDROGEN DISTRIBUTION SYSTEM FOR ELECTRIC VEHICLE AND ELECTRIC VEHICLE INCLUDING SAME

(71) Applicant: American Honda Motor Co., Inc., Torrance, CA (US)

(72) Inventors: Randy CHEUNG, Ypsilanti, MI (US); Gabor LOSCONZI, Plymouth, MI (US); John Mark JONES, White Lake, MI (US); Sandor SZENTES, Kecskemét (HU)

(21) Appl. No.: 19/094,867

(22) Filed: Mar. 29, 2025

(51) Int. Cl. H01M 8/04746; H01M 8/04082; H01M 8/04223; H01M 8/2475

(52) U.S. Cl. CPC H01M 8/04753; H01M 8/04201; H01M 8/04231; H01M 8/2475; H01M 2250/20

(57) ABSTRACT

A centralized hydrogen distribution system for an electric vehicle can include a support tower, a manifold and a pressure regulator. The centralized hydrogen distribution system can be configured to supply hydrogen from the hydrogen storage of the electric vehicle tanks to the fuel cell unit of the electric vehicle. The support tower can be configured to be centrally located among the hydrogen storage tank. A connecting structure of the support tower can be configured to connect the support tower to the electric vehicle. The manifold can be secured to the support tower and configured to be in fluid communication with each of the hydrogen storage tanks. The pressure regulator can be secured to the support tower, in fluid communication with the manifold, configured to be in fluid communication with the fuel cell unit, and configured to reduce a pressure of hydrogen flowing through the pressure regulator.

### BACKGROUND

The disclosed subject matter relates to a fuel cell electric vehicle. More particularly, the disclosed subject matter relates to methods and apparatus for distributing hydrogen gas from a plurality of storage tanks to at least one fuel cell of the electric vehicle.

An electric vehicle can include a battery assembly that is connected to one or more electric motors that drive one or more wheels of the vehicle. The battery assembly can be recharged by an internal combustion engine that is mounted on the vehicle (also known as a hybrid electric vehicle) and/or by connecting the battery to an external source of electric power. In these configurations, the electric vehicle ultimately relies on fossil fuels as the source of electric power. The electric vehicle that relies on fossil fuels might not be considered to be carbon-neutral even though the electric vehicle itself might not emit carbon monoxide during its use.

As an alternative to a hybrid electric vehicle or a battery electric vehicle, an electric vehicle can include a fuel cell system that generates electric power for charging the battery assembly. The fuel cell system can include a plurality of fuel cells (also referred to as a fuel cell stack) stacked in series to provide a desired voltage and/or stacked in parallel to provide desired current. Each fuel cell can include an anode, a cathode and electrolyte sandwiched between the anode and the cathode. There are many different types of electrolytes that can be used with the fuel cell. A proton exchange member (“PEM”) fuel cell is a fuel cell that includes polymer electrolyte membrane, uses gaseous hydrogen as a fuel, and combines the hydrogen with oxygen from the ambient environment to produce electrons, water and heat. Thus, a fuel cell system can be carbon neutral.

### SUMMARY

Some embodiments are directed to a centralized hydrogen distribution system for an electric vehicle. The electric vehicle can include a plurality of hydrogen storage tanks and at least one fuel cell unit. The centralized hydrogen distribution system can be configured to supply hydrogen from the hydrogen storage tanks to the fuel cell unit, and can include a support tower, a manifold, and a pressure regulator. The support tower can be configured to be centrally located among the hydrogen storage tanks, and can include a main trunk and a connection structure. The connecting structure can be configured to connect the support tower to the electric vehicle. The manifold can be secured to the support tower and configured to be in fluid communication with each of the hydrogen storage tanks. The pressure regulator can be secured to the support tower, in fluid communication with the manifold, configured to be in fluid communication with the fuel cell unit, and configured to reduce a pressure of hydrogen flowing through the pressure regulator.

Some embodiments are directed to a centralized hydrogen distribution system for an electric vehicle, in which the electric vehicle can include a plurality of hydrogen storage tanks and a plurality of fuel cells. The centralized hydrogen distribution system can be configured to supply hydrogen from each of the hydrogen storage tanks to each of the fuel cells, and can include a support tower, a manifold and a plurality of pressure regulators. The support tower can be configured to be centrally located among the hydrogen storage tanks, and can include a connecting structure configured to connect the support tower to the electric vehicle. The manifold can be secured to the support tower and configured to be in fluid communication with each of the hydrogen storage tanks. The plurality of pressure regulators can be secured to the support tower and in fluid communication with the manifold. Each of the pressure regulars can be configured to be in fluid communication with a respective one of the fuel cells and configured to reduce a pressure of hydrogen flowing through the pressure regulator.

Some embodiments are directed to a centralized hydrogen distribution system for an electric vehicle, in which the electric vehicle can include a plurality of hydrogen storage tanks and a plurality of fuel cells. The centralized hydrogen distribution system can be configured to supply hydrogen from each of the hydrogen storage tanks to each of the fuel cells, and can include a support tower, a manifold, a plurality of pressure regulators and a controller. The support tower can be configured to be centrally located among the hydrogen storage tanks. The manifold can be secured to the support tower and configured to be in fluid communication with each of the hydrogen storage tanks. The manifold can include a plurality of shut-off valves, and each of the shut-off valve can be configured to be in selective fluid communication with a respective one of the fuel cells. The plurality of pressure regulators can be secured to the support tower and in fluid communication with the manifold. Each of the pressure regulars can be configured to be in fluid communication with a respective one of the fuel cells and configured to reduce a pressure of hydrogen flowing through the pressure regulator. Each of the pressure regulators can include a first pressure sensor that is in fluid communication with a respective one of the pressure regulators and configured to output a pressure signal that is indicative of a pressure inside the respective one of the pressure regulators. The controller can be in electrical communication with each of the pressure regulators and configured to cause the shut-off valves to selectively and independently open and close fluid flow through the shut-off valves based on the first pressure signal received from at least one of the first pressure sensors.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a side view of an electric vehicle that includes a centralized hydrogen distribution system made in accordance with principles of the disclosed subject matter.

FIG. 2 is a perspective view of the centralized hydrogen distribution system and a hydrogen storage system of the electric vehicle of FIG. 1.

FIG. 3 is a schematic fluid circuit diagram of the centralized hydrogen distribution system and the hydrogen storage system of the electric vehicle of FIG. 1.

FIG. 4 is a schematic diagram of a control system of the centralized hydrogen distribution system of the electric vehicle of FIG. 1.

FIG. 5 is a rear view of the centralized hydrogen distribution system and the hydrogen storage system of the electric vehicle of FIG. 1.

FIG. 6 is a perspective view of the centralized hydrogen distribution system of the electric vehicle of FIG. 1.

FIG. 7 is an enlarged view of an upper portion of FIG. 6.

FIG. 8 is perspective view of a central manifold of the centralized hydrogen distribution system of the electric vehicle of FIG. 1.

FIG. 9 is a perspective view of a gas handling unit of the centralized hydrogen distribution system of the electric vehicle of FIG. 1.

FIG. 10 is a front perspective view of the gas handling unit mounted on a support tower of the centralized hydrogen distribution system of the electric vehicle of FIG. 1.

FIG. 11 is a rear perspective view of the gas handling unit mounted on the support tower of the centralized hydrogen distribution system of the electric vehicle of FIG. 1.

FIG. 12 is an enlarged view of a lower portion of FIG. 6.

FIG. 13 is a perspective view of a fuel cell system unit interface of the centralized hydrogen distribution system of the electric vehicle of FIG. 1.

FIG. 14 is an enlarged view of isolation valves and conduits that connect the centralized hydrogen distribution system to the fuel cell system of the electric vehicle of FIG. 1.

FIG. 15 is a flowchart for an algorithm that can be executed by a controller of the centralized hydrogen distribution system of the electric vehicle of FIG. 1.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

An electric vehicle can be a passenger vehicle, a bus, a commercial transport vehicle, a construction vehicle, a boat, a spacecraft, or an aircraft. A commercial transport vehicle can be a van, a truck, or a tractor-trailer (also referred to as a semi-trailer truck, a trailer truck, or a semi) that is configured to transport products from location to location. Tractor-trailers can be advantageous for carrying large quantities of products or heavy products over short distances and long distances. A conventional tractor-trailer can include a compression-ignition internal combustion engine. Not only does the engine emit carbon compounds and undesirable compounds of nitrogen, but also particulates such as soot. Thus, it can be advantageous to provide a tractor-trailer with at least one electric motor and a battery pack that powers the electric motor(s).

In order to provide an advantageous range for an electric vehicle, the battery should have a large energy storage capacity. However, current-technology batteries are relatively heavy and the increased mass of the battery pack could adversely impact the travel range between charging events. A fuel cell system could overcome this potential disadvantage by charging the battery pack 15 while the electric vehicle is traveling, thus extending the driving range of the electric vehicle.

The fuel cell can charge the battery pack while the electric vehicle is travelling. This can increase the range of the electric vehicle as compared to a plug-in battery-powered electric vehicle. However, a single fuel cell that can meet the desired charging rate might exceed the space available on/in the electric vehicle or exceed the desired weight for the electric vehicle. Additionally, or alternatively, the support equipment such as but not limited to, an air supply system and a cooling system, might exceed the space available on/in the electric vehicle or exceed the desired weight for the electric vehicle. Conversely, a single fuel cell might not meet the desired charging rate for the charging the battery pack. Thus, it might be advantageous to provide the electric vehicle with a plurality of fuel cells.

In order to charge the battery pack via fuel cell technology while traveling, the electric vehicle can carry an on-board supply of hydrogen gas. However, the tank(s) for storing a volume of hydrogen gas that provides an advantageous range for the electric vehicle can be relatively large. It could be desirable to provide the electric vehicle with a plurality of tanks.

However, the plurality of fuel cells and the plurality of tanks can result in complicated plumbing, can require complicated control of the hydrogen supplied by each tank and can occupy an undesirable volume available in/on the electric vehicle. Thus, it can be advantageous to creatively package a hydrogen distribution system that occupies a minimum volume of the vehicle, is capable of supplying hydrogen to any one or combination of the fuel cells from any one or combination of the tanks, and is also relatively simple to control the flow of hydrogen from the tanks(s) to the fuel cell(s).

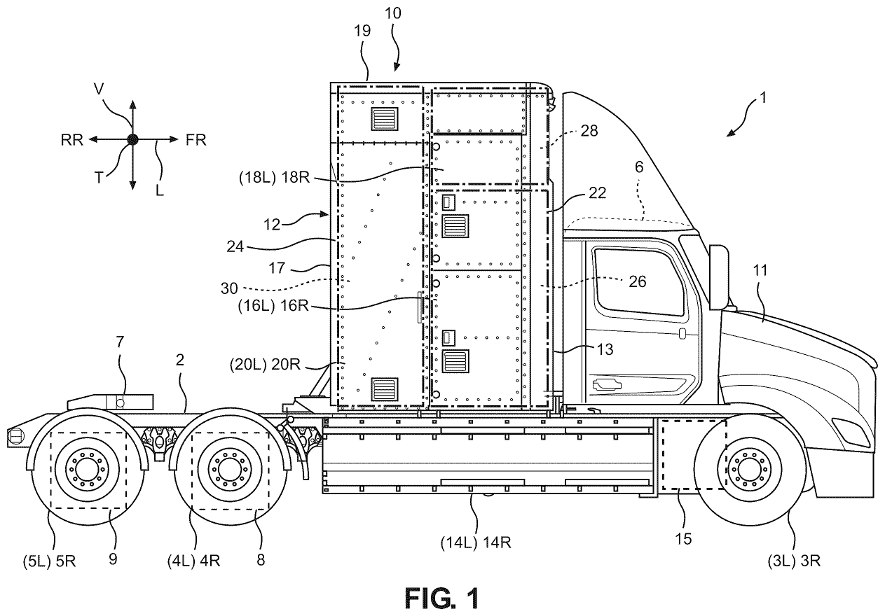

FIG. 1 illustrates an embodiment of an electric vehicle 1 (hereinafter “vehicle”) made in accordance with principles of the disclosed subject matter. The vehicle 1 can extend in a longitudinal direction L, a transverse direction T and a vertical direction V. The longitudinal direction L includes a front direction FR and a rear direction RR and the transverse direction includes a left direction LT and a right direction RT. The vehicle 1 shown in FIG. 1 can be specialized for use as a commercial transport vehicle.

The vehicle 1 can include a main power system 10, a chassis 2, a pair of front wheels 3L, 3R and a front pair of dual rear wheels 4L, 4R, a rear pair of dual rear wheels 5L, 5R, a cab 6, a fifth wheel 7, and a hood 11. The left-side wheels 3L, 4L, 5L are obstructed from view and can be the same as the right-side wheels 3R, 4R, 5R. The wheels 3L, 3R, 4L, 4R, 5L, 5R can be connected to and suspended from the chassis 2 in any appropriate manner. The chassis 2 can include a pair of frame rails that extend in the longitudinal direction L from a location in front of the front wheels 3L, 3R to a location behind the rear pair of dual wheels 5L, 5R. The frame rails can be spaced apart from each other in the transverse direction T. The cab 6 and the fifth wheel 7 can be mounted on the chassis 2 by any appropriate manner. The main power system 10 can be mounted on the chassis 2 at a location that is adjacent to the cab 6 and in front of the front pair of dual rear wheels 4L, 4R in the longitudinal direction L. The main power system 10 can be connected to the chassis 2 by any appropriate manner.

The vehicle 1 can include a first electric motor 8 that drives the front pair of dual rear wheels 4L, 4R and a second electric motor 9 that drives the rear pair of dual rear wheels 5L, 5R. The electric motors 8, 9 are schematically illustrated in phantom. The main power system 10 can generate, store, and distribute electric power to the electric motors 8, 9 and supply electric power generated by either of the electric motors 8, 9 to a battery pack 15 of the main power system 10.

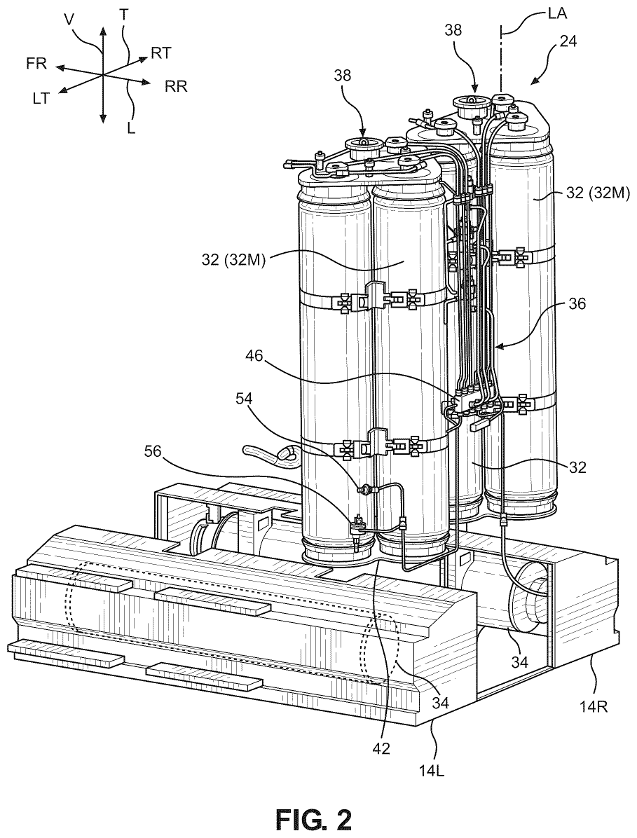

The main power system 10 can include a main housing 12 and a pair of saddle enclosures 14L, 14R. The left-side saddle enclosure 14L is shown in FIG. 2 and obstructed from view in FIG. 1. The main housing 12 can be mounted on the chassis 2 at a location that is behind the cab 6 in the longitudinal direction L and in front of the front pair of rear dual wheels 4L, 4R in the longitudinal direction L. The main housing 12 can extend along the top of the chassis 2 in the longitudinal direction L and the transverse direction T. The main housing 12 can extend away from the chassis in the vertical direction V.

The main power system 10 can include a fuel cell system 22 (also referred to as an FCS or as an FCS system) that generates electricity for powering the vehicle 1 and a hydrogen storage system 24 (also referred to as a HSS or as a HSS system) for storing a supply of hydrogen gas for the fuel cell system 22. The FCS 22 and the HSS 24 are schematically illustrated in phantom. FIG. 2 shows the HSS 24 in its orientation in the vehicle 1.

The main power system 10 can include a battery pack 15 that includes a plurality of battery cells. Each of the battery cells can store and discharge electricity. The battery pack 15 can be mounted between the frame rails of the chassis 2. The battery pack 15 can be in electrical communication with the FCS 22 and the electric motors 8, 9. The battery pack 15 is obscured from view in FIG. 1 and shown in phantom.

The main housing 12 can contain the FCS 22 and the HSS 24 and shelter these systems 22, 24 from the ambient environment. The main housing 12 can include a plurality of access panels 13, 16L, 16R, 17, 18L, 18R, 19, 20L, 20R. The left-side panels 16L, 18L, 20L are obstructed from view and can be a mirror copy of the right-side panels 16R, 18R, 20R. The access panels 16L, 16R, 17, 18L, 18R, 20L, 20R can be removably or pivotally mounted to provide convenient access to the components and systems of the main power system 10. The front access panel 13 can cover a front side of the main housing 12 that faces the rear side of the cab 6. The lower access panels 16L,16R can selectively open and close a fuel cell compartment 26 illustrated in phantom. The upper access panels 18L, 18R can selectively open and close a heat exchanger compartment 28 and an upper portion of the fuel cell compartment 26. The compartments 26, 28 are schematically illustrated in phantom. The rear panel 17 and the fuel access panels 20L, 20R can selectively open and close a hydrogen compartment 30 that is schematically illustrated in phantom. The rear panel 17 can extend along the entirety of the rear side of the main housing 12. The top panel 19 can cover at least a portion of the top side of the main housing 12 and can include an exhaust outlet for heat exchangers housed in the heat exchanger compartment 28.

The saddle enclosures 14L, 14R can be connected to and extend along a respective one of the frame rails of the chassis 2 in the longitudinal direction L and away from the respective frame rail in the vertical direction V. The saddle enclosures 14L, 14R can protect respective portions of the main power system 10 from objects, dirt, debris and fluids. The saddle enclosures 14L, 14R can be located between the left front wheel 3L, 3R and the forward dual wheels 4L, 4R. The saddle enclosures 14L, 14R can extend away from the respective frame rail in the transverse direction T. The saddle enclosures 14L, 14R can be connected to the chassis 2 by any appropriate manner such as, but not limited to, threaded fasteners, clamps, straps, clips, hinges, or any combination of these attachment devices.

The FCS 22 can be housed within the fuel cell compartment 26 and include at least one fuel cell stack and the components and systems that supply hydrogen and oxygen to the fuel cell stack, control the electrical power output, collect and remove the water produced by the fuel cell stack, circulate cooling water for the fuel cell stack, and humidify the ambient air prior to supplying the ambient air to the fuel cell stack.

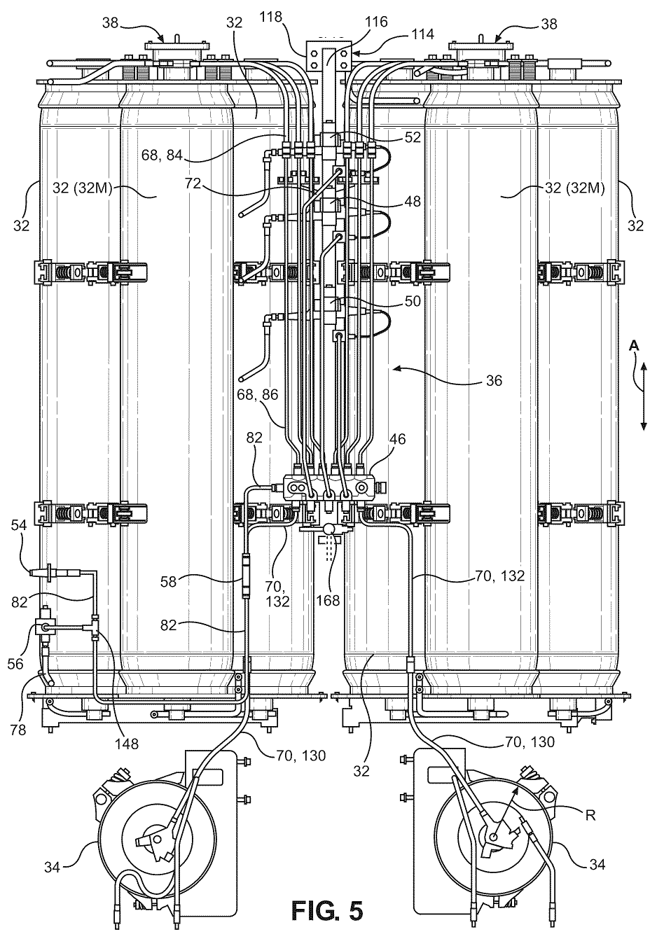

The HSS 24 can be in fluid communication with FCS 22 and housed within the saddle enclosures 14L, 14R and the hydrogen compartment 30. The hydrogen compartment 30 can also be referred to as a fuel storage compartment. Referring to FIG. 2, the HSS 24 can include a plurality of vertical tanks 32 mounted inside the hydrogen compartment 30 of the main housing 12 and a pair of horizontal tanks 34 mounted on the frame rails of the chassis 2. Two of the vertical tanks 32 are obstructed from view in FIG. 2 and all six vertical tanks 32 are shown in FIG. 5. The left-side horizontal tank 34 is shown in phantom in FIG. 2. Each of the tanks 32, 34 can be referred to as a hydrogen gas storage tank.

The vertical tanks 32 can be mounted inside of the hydrogen compartment 30 in the spatial relationship illustrated in FIG. 2. Although FIG. 2 shows six vertical tanks 32, any appropriate number of vertical tanks 32 can be mounted inside of the hydrogen compartment 30 in order to achieve the desired hydrogen capacity and performance of the vehicle 1. The vertical tanks 32 can be oriented with their longitudinal axis LA extending parallel to, or substantially parallel to, the vertical direction V of the vehicle 1. Further, the vertical tanks 32 can be arranged in triangular arrays. This orientation can provide a minimum footprint within the main housing 12 for a predetermined target hydrogen gas storage capacity. This minimum footprint can contribute to a packaging layout of the FCS 22, the HSS 24, and a thermal management system for cooling the FCS 22. This minimum footprint can promote ease of assembly onto the vehicle 1, ease of access for routine maintenance, and/or ease of removing/reinstalling/replacing component(s) and system(s) of the FCS 22.

The horizontal tanks 34 can be located between the chassis 2 and a respective one of the saddle enclosures 14L, 14R in the transverse direction T. The saddle enclosures 14L, 14R can shield the horizontal tanks 34 against objects, fluid, dirt and debris.

Each of the tanks 32, 34 can independently expand and contract due to changing pressure of the hydrogen gas contained in each of the tanks 32, 34. Referring to FIG. 5, each of the tanks 32, 34 can expand and contract in a radial direction R (shown for horizontal tanks 34) of the tanks 32, 34 and an axial direction A (shown for the vertical tanks 32) of the tanks 32, 34 while supplying hydrogen gas to the fuel cells. The axial direction A for the vertical tanks 32 can be parallel to longitudinal axis LA and the axial direction A for the horizontal tanks 34 can be parallel to or substantially parallel to the longitudinal direction L. The vertical tanks 32 can be oriented in the hydrogen compartment 30 with their longitudinal direction LA parallel to or substantially parallel to the vertical direction V of the vehicle 1. In this orientation, the vertical tanks 32 can have a radial direction R that lies in a plane that extends in the longitudinal direction L and the transverse direction T of the vehicle 1. The radial direction R of the horizontal tanks 34 can lie in a plane that extends in the transverse direction T and the vertical direction V.

Referring to FIGS. 2 and 5, the HSS 24 can include two tank support assemblies 38 that can be the same as or similar to each other. Each of the tank support assemblies 38 can constrain a respective set of the vertical tanks 32 in their predetermined location within the hydrogen compartment 30 while also allowing for expansion and contraction of each of the vertical tanks 32 in the axial direction A and the radial direction R. Axial expansion and contraction vertical tanks 32 can also be referred to as longitudinal expansion and contraction of the vertical tanks 32.

The main power system 10 can include a centralized hydrogen distribution system 36 that can connect the HSS 24 to one or more fuel cells of the FCS 22 and supply hydrogen gas from each of the tanks 32, 34 to all of the fuel cell(s).

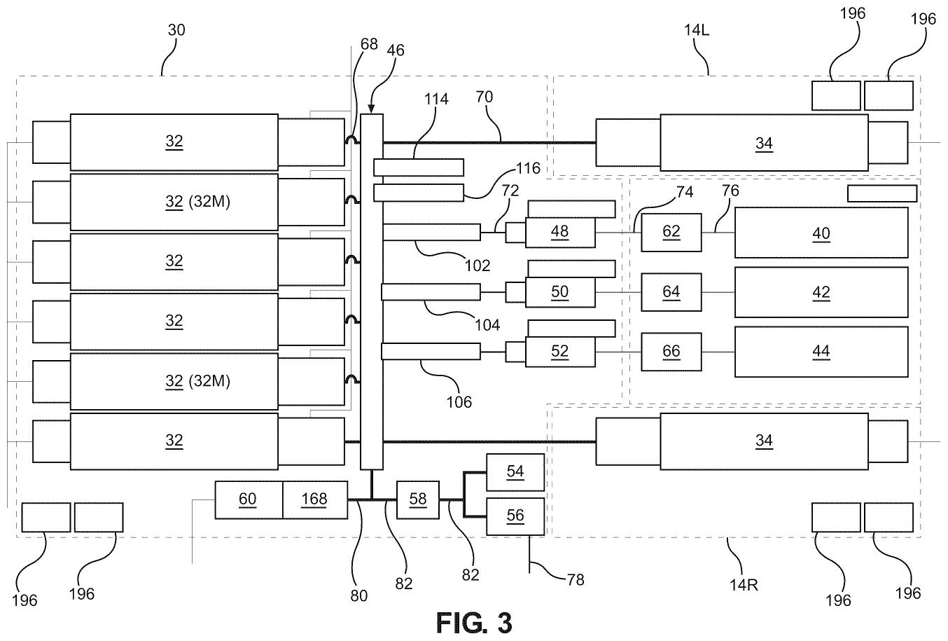

Referring to FIG. 3, FCS 22 include three fuel cell units 40, 42, 44 and the HSS 24 can include the eight hydrogen storage tanks 32, 34. Each of the fuel cell units 40, 42, 44 can include a fuel cell stack and a balance of plant. The balance of plant can include structures that support the operation of the fuel cell stacks such as, but not limited to, filter(s), a compressor, an intercooler, a humidifier, valve(s), a water separator, and a blower. The balance of plant can include structure(s) that support, mount and/or house the fuel cell stacks and the balance of plant structures that support the operation of the fuel cell stacks.

The centralized hydrogen distribution system 36 (hereinafter system 36) can be configured to distribute hydrogen gas stored in each of the hydrogen gas storage tanks 32, 34 to any one or combination of the fuel cell units 40, 42, 44. The system 36 can be configured to allow an even flow across all eight of the hydrogen storage tanks 32, 34. The system 36 can distribute hydrogen within the system 36 at a relatively high pressure and can permit a relatively high flow rate desired for supplying each of the fuel cell units 40, 42, 44. The system 36 can be configured to be compatible with communication fueling stations and non-communication fuel systems. The system 36 can be configured to comply with present industry and government standards.

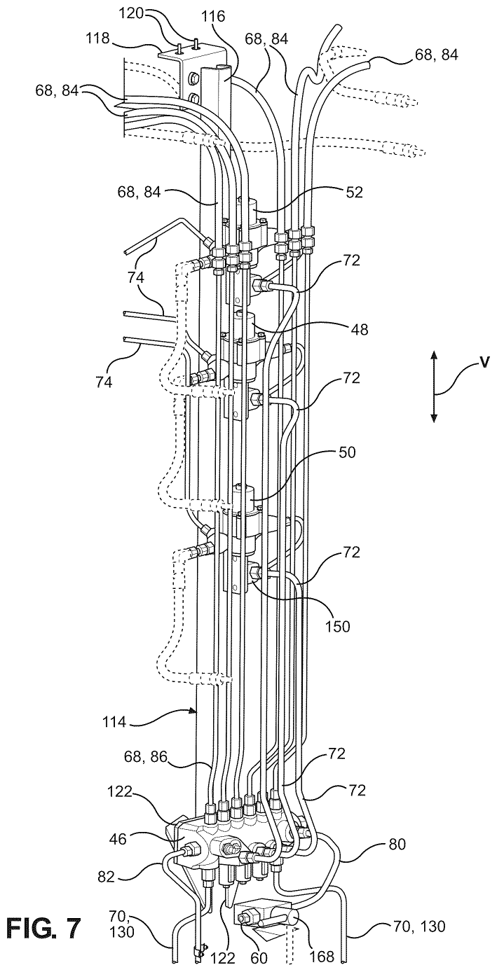

Referring to FIGS. 3 and 5-7 collectively, the system 36 can include a system manifold 46, a plurality of gas handling units (GHUs) 48, 50, 52, an inlet port 54, a purge solenoid 56, a check valve 58, a secondary port 60, a plurality of isolation valves 62, 64, 66, a plurality of first high-pressure conduits 68, a plurality of second high-pressure conduits 70, a plurality of third high-pressure conduits 72, a fourth high-pressure conduit 82, a plurality of low-pressure conduits 74, 76, a purge conduit 78, a secondary conduit 80 and a plurality of second manifolds 150. Only one of the six first high-pressure conduits 68 is indicated with a reference number in FIGS. 3 and 5 for simplicity and clarity of the drawings and only one of the three second manifolds 150 is indicated with a reference number in FIG. 7. Each of the GHUs 48, 50, 52 can also be referred to as a pressure regulator.

Referring to FIGS. 5-7, the system 36 can include a support tower 114. Each of the system manifold 46, the pressure regulators 48, 40, 52 and the second manifolds 150 can be connected to the support tower 114. Support tower 114 can be elongated in the vertical direction V of the vehicle 1. The system manifold 46 can be mounted at the bottom of the support tower 114, the pressure regulators 48, 50, 52 can be mounted onto the support tower 114 at locations that are spaced apart from each other and stacked above the system manifold 46, and the second manifolds 150 can be mounted onto the support tower 114 at locations that are spaced apart from each other and stacked above the system. Each of the first high pressure conduits 68 can extend parallel to or substantially parallel to the support tower 114 as the conduits 68 extend from the system manifold 46. Each of the inlet port 54, the purge solenoid 56, the check valve 58 and the secondary port 60 can be spaced away from the support tower 114. The support tower 114 can be installed onto the vehicle 1 as a single unit that includes the system manifold 46, the pressure regulators 48, 40, 52, the second manifolds 150 and the first high-pressure conduits 68.

Referring to FIGS. 2 and 5, each of the tank support assemblies 38 can arrange three of the vertical tanks 32 into a triangular shape as viewed from above, and the pair of tank support assemblies 38 can be arranged in the hydrogen compartment 30 so that a space separates the middle tank 32M of each array. The support tower 114 can be located in this space that is between the middle tank 32M of one of tank support assemblies 38 and the middle tank 32M of the other of the of the tank support assemblies 38. This space can be centrally located between the two tank support assemblies 38. The support tower 114 can be oriented in the space so that the system manifold 46, the pressure regulators 48, 50, 52, the second manifolds 150 and a majority length of the first high pressure conduits 68 are located in the space. Thus, the support tower 114 can efficiently package the system manifold 46, the pressure regulators 48, 50, 52, the first high pressure conduits 68 and the second manifolds 150 within the main housing 12. This packaging can also facilitate access to the system manifold 46, the pressure regulators 48, 50, 52, the second manifolds 150 and a majority length of the first high pressure conduits 68 for inspection, maintenance and repair. Further, the support tower 114 can form a central location of the system 36.

Referring to FIGS. 5-7, the support tower 114 can include a main trunk 116 and a connecting structure 118. The main trunk 116 can be a hollow, rectangular tube. The connecting structure 118 can be mounted onto a top end of the main trunk 116 and connected to the main trunk by any appropriate manner such as, but not limited to, welding, threaded fasteners, rivets, adhesives, clamps, clips, or any combination of these structures. The connecting structure 118 can be any appropriate structure such as, but not limited to, a flange or a bracket. The connecting structure shown in FIGS. 5-7 is configured as an L-shaped mounting bracket that includes a first leg that is mounted onto the main trunk 116 can second leg that protruded away from the main trunk 116. A plurality of threaded fasteners 120 (FIG. 7) can connect the connecting structure 118 to the main housing 12 and/or any appropriate structure connected to the vehicle 1 that is located inside of the main housing 12.

Referring to FIG. 7, the support tower 114 can include a manifold bracket 122 connected onto a bottom end of the main trunk 116 by any appropriate manner such as, but not limited to, welding, threaded fasteners, rivets, adhesives, clamps, clips, or any combination of these structures. The manifold bracket 122 can protrude away from the bottom end of the support tower 114 along the vertical direction V of the vehicle 1 and can protrude below the system manifold 46 in the vertical direction V. The system manifold 46 can be connected onto the manifold bracket 122 by an appropriate manner such as, but not limited to, welding, threaded fasteners, rivets, adhesives, clamps, clips, or any combination of these structures.

During refueling, the system manifold 46 can distribute hydrogen gas from the inlet port 54 to each of the tanks 32, 34. During operation of the fuel cell units 40, 42, 44, the system manifold 46 can distribute hydrogen gas to each of the fuel cell units 40, 42, 44. That is, all of the hydrogen gas can flow through the system manifold 46 during refueling of the HSS 24, and all of the hydrogen gas supplied to the FCS 22 can flow through the system manifold 46 before reaching the FCS 22.

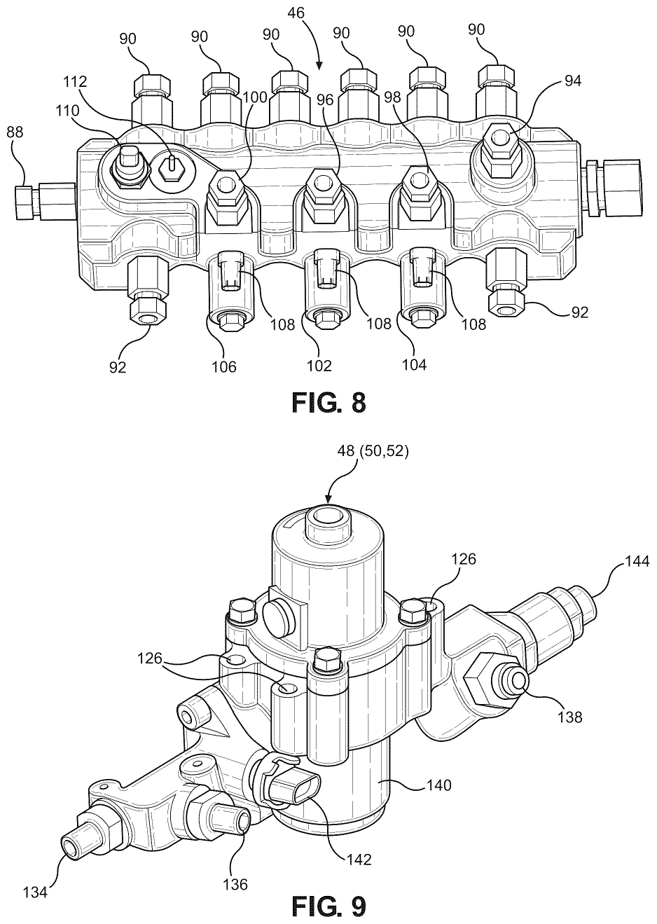

Referring to FIG. 8, the system manifold 46 can include a primary fitting 88, a plurality of first tank fittings 90, a plurality of second tank fitting 92, a secondary fitting 94, a plurality of fuel cell fittings 96, 98, 100, a plurality of shut-off valves 102, 104, 106, a plurality of electrical connectors 108, a pressure sensor 110 and a temperature sensor 112. The system manifold 46 can include an internal chamber that is in fluid communication with each of the fittings 92, 94, 96, 98, 100, the shut-off valves 102, 104, 106 and the pressure sensor 110.

Each of the first high pressure conduits 68 can be connected to and extend from a respective one of the first tank fittings 90 and a respective one of the vertical tanks 32. Each of the second high pressure conduits 70 can be connected to and extend from a respective one second tank fittings 92 and a respective one of the horizontal tanks 34. That is, each of the tanks 32, 34 can be in fluid communication with the system manifold 46.

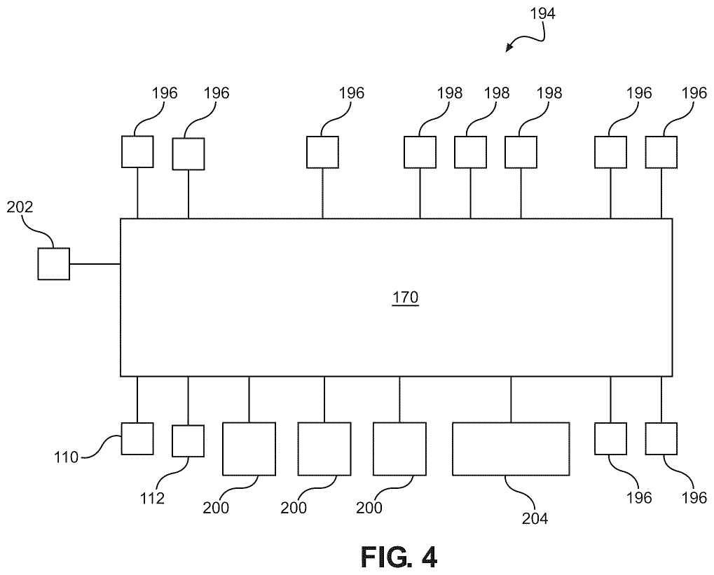

Each of the shut-off valves 102, 104, 106 can be any appropriate electrically actuated valve. Each of the electrical connectors 108 can be in electrical communication with a respective one of the shut-off valves 102, 104, 106. Each of the shut-off valves 102, 104, 106 can be a normally closed valve that closes fluid communication between the inner chamber of the system manifold 46 and a respective one of the fuel cell fittings 96, 98, 100 when the respective one of shut-off valves 102, 104, 106 is de-energized. Each of the shut-off valves 102, 104, 106 can open fluid communication between the inner chamber of the system manifold 46 and a respective one of the fuel cell fittings 96, 98, 100 when the respective one of shut-off valves 102, 104, 106 is energized. Energization of the shut-off valves 102, 104, 106 can be done manually by a user or automatically by a controller 170 (FIG. 4).

The pressure sensor 110 can be mounted on and in fluid communication with the inner chamber of the system manifold 46 and configured to output a signal that includes data that is indicative of a pressure of the hydrogen gas within the inner chamber.

The temperature sensor 112 can be mounted on and in thermal communication with the hydrogen gas in the inner chamber of the system manifold 46 and configured to output a signal that includes data that is indicative of a temperature of the hydrogen gas within the inner chamber.

Each of the sensors 110, 112 can be in electrical communication with the controller 170. The controller 170 can be configured to energize or de-energize the shut-off valves 102, 104, 106 based on data received from the sensors 110, 112. Further details of the controller 170 are described below with reference to FIG. 4.

In order to store an amount of hydrogen gas in the tanks 32, 34 that can provide an advantageous travel range for the vehicle 1, the hydrogen gas can be stored at a relative high pressure. However, this relatively high storage pressure can be higher than a desired operating pressure for each of the fuel cell units 40, 42, 44. The pressure regulators 48, 50, 52 can be configured to reduce the relatively high storage pressure to a relatively lower operating pressure. Each of the pressure regulators 48, 50, 52 can include any appropriate internal structure that can reduce the pressure of the hydrogen gas from the storage pressure to the operating pressure.

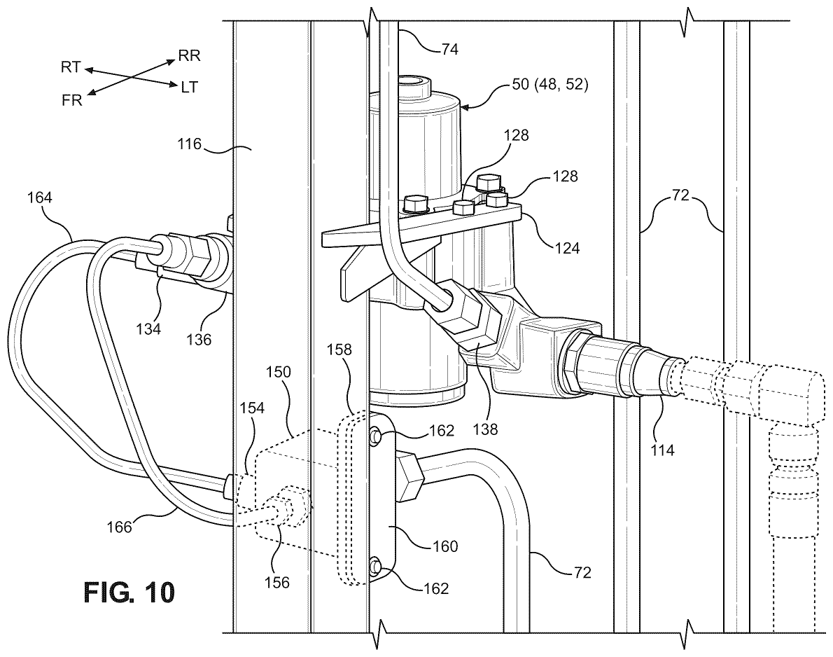

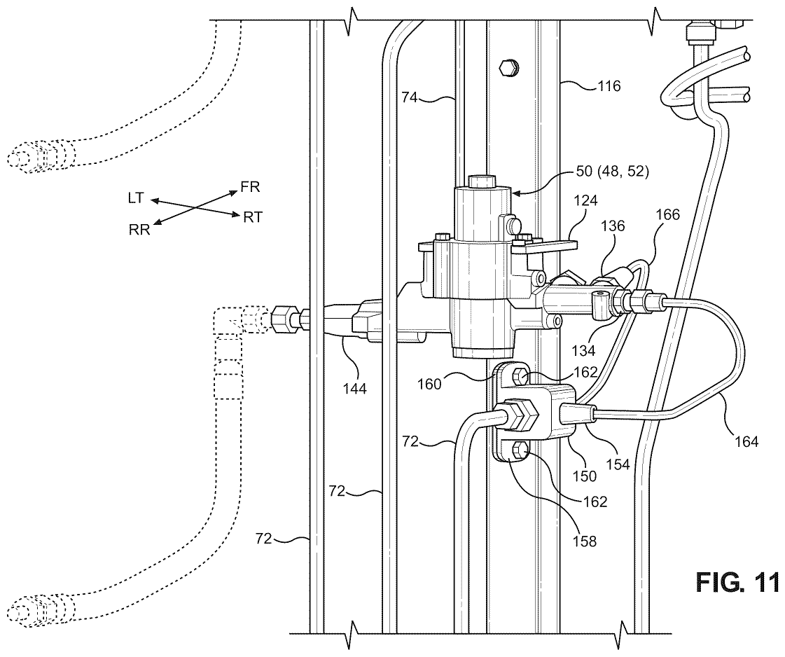

FIG. 10 is a front perspective view of the second pressure regulator 50 and a portion of the support tower 114. FIG. 11 is a rear perspective view of the second pressure regulator 50 and a portion of the support tower 114. The support tower 114 can include a plurality of regulator brackets 124, one for each of the pressure regulators 48, 50, 52. All of the regulator brackets 124 can be the same as or similar to the regulator bracket 124 shown in FIGS. 10 and 11. The regulator brackets 124 can be mounted onto the main trunk 116 at predetermined intervals that can be equal or unequal to each other. The regulator brackets 124 can be connected to the main trunk 116 by an appropriate manner such as, but not limited to, welding, threaded fasteners, rivets, adhesives, clamps, clips, or any combination of these structures. Each of the regulator brackets 124 can include a pair of arms that extends onto a respective one of the pressure regulators 48, 50, 52. Each of the regular brackets 124 can include a recessed portion and the main trunk 116 can be inserted into the recessed portion.

Referring to FIG. 9, each of the pressure regulators 48, 50, 52 can include a plurality of fastener holes 126. Returning to FIGS. 10 and 11, a plurality of threaded fasteners 128 can extend through the regulator bracket 124 and into a respective one of the fastener holes 126 to secure each of the regulators 48, 50, 52 to a respective one of the regulator brackets 124.

Referring to FIGS. 5, 6, 8 and 12 collectively, the inlet port 54 can have any appropriate structure that complies with any appropriate government or industry standard such as, but not limited to SAE J2600. The inlet port 54 can be configured to be connected to a refueling structure of an infrastructure storage tank that is separate from the vehicle 1 so that the tanks 32, 34 can be refilled with hydrogen gas.

The fourth high pressure conduit 82 (also referred to as a fill line) can be connected to and extend from each of the primary fitting 88 and the inlet port 54. The check valve 58 can be located in the fourth high pressure conduit 82. The check valve 58 can be configured to permit hydrogen gas to flow from the inlet port 54, through the check valve 58 and into the primary fitting 88, and prevent hydrogen gas from flowing from the primary fitting 88 to the inlet port 54.

It can be desirable to purge the fourth high pressure conduit 82 after the tanks 32, 34 have been filled/refilled at a hydrogen fueling station. If the fueling station is not configured to purge the fourth high pressure conduit 82, the purge solenoid 56 can be used to purge the fourth high pressure conduit 82.

Referring to FIGS. 3, 5, 6 and 12, the fourth high pressure conduit 82 can include a branch connector 148 and the system 36 can include a branch line 146 that is connected to and extends from each of the branch connector 148 and the purge solenoid 56. The purge solenoid 56 can be connected to and in fluid communication with a segment of the fourth high pressure conduit 82 that extends from the inlet port 54 to the check valve 58. The purge solenoid 56 can include a solenoid-actuated valve that can be selectively opened and closed. Hydrogen gas in the fourth high pressure conduit 82 between the check valve 58 and the inlet port 54 can exit the fourth high pressure conduit 82 if the purge solenoid 56 is activated to open the valve.

The fourth high pressure conduit 82 can be divided into three segments. The first segment can be connected to and extend from each of the inlet port 54 and the branch connector 148. The second segment can be connected to and extend from each of the branch connector 148 and the check valve 58. The third segment can be connected to and extend from the check valve 58 to the primary fitting 88 of the system manifold 46.

Referring to FIGS. 5-7, each of the first high-pressure supply conduits 68 can include a first flexible conduit 84 and a first rigid conduit 86. Only one of the first flexible conduits 84 is designated with a reference number in FIG. 5 and only one of the first rigid conduits 86 is designated with a reference number in FIGS. 5-7 for simplicity and clarity of the drawings. Each of the first flexible conduits 84 can be connected to a respective one of the vertical tanks 32 and a respective one of the first rigid conduits 86 and each of the first rigid conduits 86 can be connected to and extend from a respective one of the first flexible conduits 84 and a respective one of the first tank fittings 90 of the system manifold 46.

The first flexible conduits 84 can be elastically deformable and/or include a predetermined amount of slack so that the first flexible conduits 84 can move relative to the system manifold 46 as the respective one of the vertical tanks 32 expands and contracts in a radial direction R (FIG. 5) and/or along the axial direction A (FIG. 5). Each of the first flexible conduits 84 can be fabricated from any appropriate flexible material that can withstand the desired high pressure of the hydrogen gas and provide the desired movement/deformation to accommodate the expansion/contraction of the respective one of the vertical tanks 32. Both ends of each of the first flexible conduits 84 can include any appropriate fitting that can facilitate a connection with the respective one of the vertical tanks 32 and the respective one of the first rigid conduits 86.

Each of the first rigid conduits 86 can have a rigidity that is greater than the rigidity of the first flexible conduits 84. Each of the first rigid conduits 86 can be fabricated with the same or similar predetermined shape and length. Each of the first rigid conduits 86 can be fabricated from any appropriate material that can withstand the desired high pressure of the hydrogen gas and maintain a desired shape of the rigid conduits 86. Both ends of each of the first rigid conduits 86 can include any appropriate fitting that can facilitate a connection with the first tanks fittings 90 of the system manifold 46 and the respective one of the first flexible conduits 84.

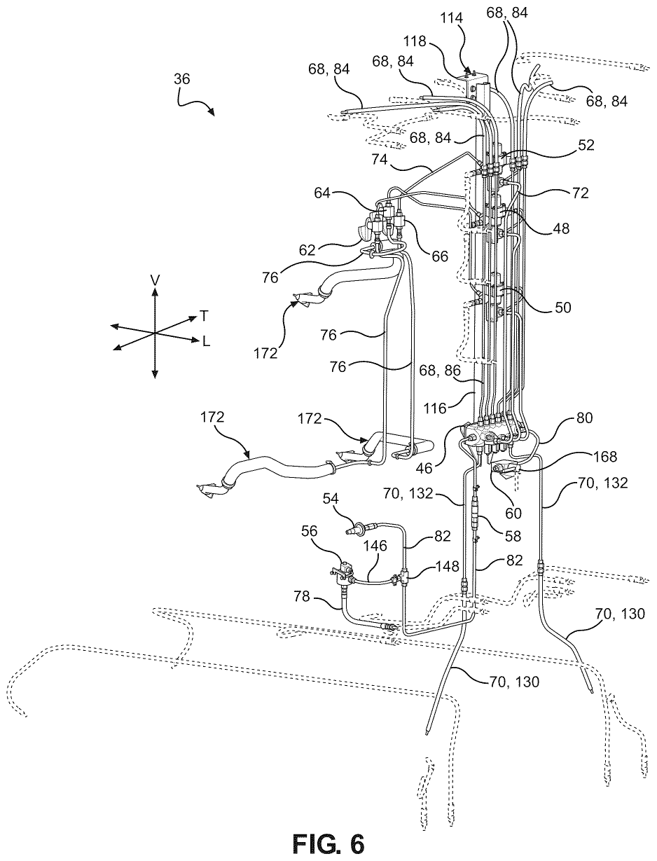

Referring to FIGS. 5 and 6, each of the second high-pressure supply conduits 70 can include a second flexible conduit 130 and a second rigid conduit 132. Each of the second flexible conduits 130 can be connected to a respective one of the horizontal tanks 34 and a respective one of the second rigid conduits 132 and each of the second rigid conduits 132 can be connected to and extend from a respective one of the second flexible conduits 130 and a respective one of the second tank fittings 92 of the system manifold 46.

The second flexible conduits 130 can be elastically deformable and/or include a predetermined amount of slack so that the second flexible conduits 130 can move relative to the system manifold 46 as the respective one of the horizontal tanks 34 expands and contracts in a radial direction R (see, for example, FIG. 5) and/or along the axial direction A (see, for example, FIG. 5). Each of the second flexible conduits 130 can be fabricated from any appropriate flexible material that can withstand the desired high pressure of the hydrogen gas and provide the desired movement/deformation to accommodate the expansion/contraction of the respective one of the horizontal tanks 34. Both ends of each of the second flexible conduits 130 can include any appropriate fitting that can facilitate a connection with the respective one of the horizontal tanks 34 and the respective one of the second rigid conduits 132.

Each of the second rigid conduits 132 can have a rigidity that is greater than the rigidity of the second flexible conduits 130. Each of the second rigid conduits 132 can be fabricated with the same or similar predetermined shape and length. Each of the second rigid conduits 132 can be fabricated from any appropriate material that can withstand the desired high pressure of the hydrogen gas and maintain a desired shape of the second rigid conduits 132. Both ends of each of the second rigid conduits 132 can include any appropriate fitting that can facilitate a connection with the second tank fittings 92 of the system manifold 46 and the respective one of the second flexible conduits 130.

Each of the first rigid conduits 86 can have a similar shape and length and each of second rigid conduits 132 can have a similar shape and length. Each of the flexible conduits 84, 130 can have a unique length and shape. The lengths and shapes of the each of the conduits 84, 86, 130, 132 can be determined based on a desired pathway from the system manifold 46 to the respective one of the tanks 32, 34 that can minimize pressure losses and avoid other components of the system 36 and the HSS 24.

FIG. 9 is a perspective view of the first pressure regulator 48. The second and third pressure regulators 50, 52 can be the same as or similar to the first pressure regulator 48. Each of the pressure regulators 48, 50, 52 can include a first inlet 134, a second inlet 136, an outlet 138, a main body 140, an electrical connector 142 and a vent 144.

FIGS. 10 and 11 only show the second manifold 150 for the second pressure regulator 50. The second manifold 150 is obstructed from view in FIG. 10 by the main trunk 116 and is therefore shown in phantom. Each of the second manifolds 150 can be the same as or similar to the second manifold shown in FIGS. 10 and 11. Each of the second manifolds 150 can be mounted onto the main trunk 116 at a location that is adjacent a respective one of the pressure regulators 48, 50, 52.

The tower support 114 can include a plurality of trunk brackets 160 mounted onto the main trunk 116 at predetermined intervals that can be equal or unequal to each other. Each of the trunk brackets 160 can include a first portion that abuts a surface of the main trunk 116 and is mounted onto the main trunk 116 and a second portion that protrudes away from the surface of the main trunk 116 on which the trunk brackets 160 are mounted. Each of the second manifolds 150 can include mounting flange 158 that can be connected onto a respective one of the trunk brackets 160 by a plurality of threaded fasteners 162.

Each of the second manifolds 150 can include an inlet 152 and a pair of outlets 154, 156. Both outlets 154, 156 are obstructed from view in FIG. 10 and are shown phantom. The second outlet 156 is obstructed from view in FIG. 11 by the second pressure regulator 50. The first outlet 154 can be located on a surface of the second manifold 150 that generally faces in the right directed RT of the vehicle 1 and the second outlet 156 can be located on a surface of the second manifold 150 that generally faces in the front direction FR of the vehicle 1. Each of the second manifolds 150 can include an inner chamber that is in fluid communication with each of the inlet 152 and the outlets 154, 156.

Each of the third high pressure conduits 72 can be connected to and extend from each of the system manifold 46 and a respective one of the second manifolds 150. Each of the third high pressure 72 can include a first fitting that mates with a respective one of the fuel cell fittings 96, 98, 100 on the system manifold 46. Each of the third high pressure conduits 72 can include a second fitting that mates with a fitting of the inlet 152 of a respective one of the second manifolds 150.

The system 36 can include a first manifold line 164 and a second manifold line 166. The first manifold line 164 can be connected to and extend from each of the first outlet 154 of the second manifold 150 and the first inlet 134 of a respective one of the pressure regulators 48, 50, 52. The second manifold line 166 can be connected to and extend from each of the second outlet 156 of the second manifold 150 and the second inlet 136 of a respective one of the pressure regulators 48, 50, 52.

Any one or any combination of the fuel cell units 40, 42, 44 can be operated at any given time to generate electricity. The isolation valves 62, 64, 66 and/or the shut-off valves 102, 104, 106 can be selectively closed to stop the supply of hydrogen gas to any one or any combination of the fuel cell units 40, 42, 44 and isolate any one or any combination of the fuel cell units 40, 42, 44 from the system manifold 46 and the HSS 24. Each the isolation valves 62, 64, 66 can selectively open and close fluid communication between the each of the fuel cell units 40, 42, 44 and each of the pressure regulators 48, 50, 52, respectively. That is, each of the isolation valves 62, 64, 66 can be configured to selectively open and close fluid communication through the respective second low-pressure conduit 76.

Each of the isolation valves 62, 64, 66 can include a manual input that is configured to permit a user to cause the respective one of the isolation valves 62, 64, 66 to selectively open and close. The manual input can be any appropriate structure such as, but not limited to, a handle, a knob, a wheel, an electric switch, a push button, or a touch screen with a representative icon. The manual input can be configured to be selectable by movement or touch.

The isolation valves 62, 64, 66 can facilitate service, maintenance and replacement of the respective one of the fuel cell units 40, 42, 44. The isolation valves 62, 64, 66 can permit an operator to shut down any one or pair of the fuel cell units 40, 42, 44 that is/are performing below a desirable level while allowing a remaining pair or one of the fuel cell units 40, 42, 44 to continue operating so that vehicle 1 can remain drivable.

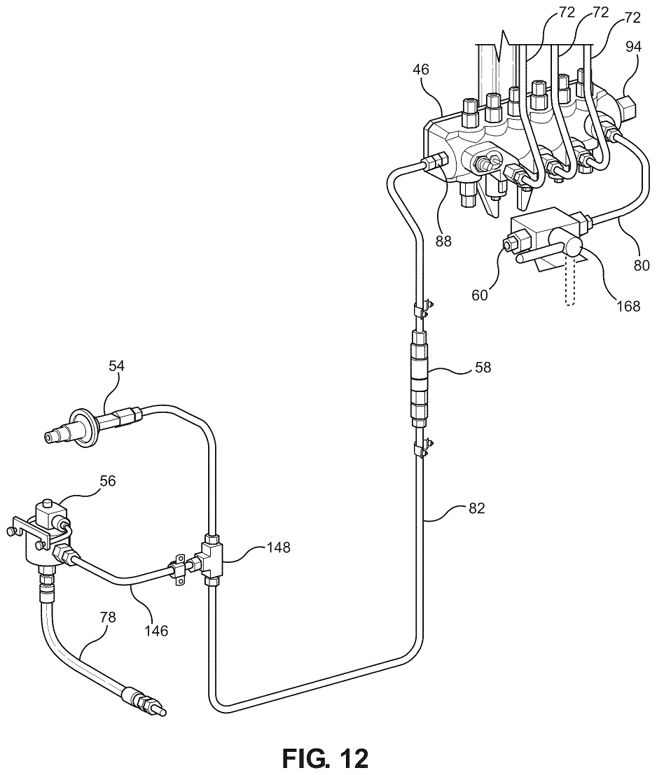

Hydrogen gas that has been reduced to the operating pressure can exit the respective one of the pressure regulators 48, 50, 52 via the outlet 138 and be directed to a respective one of the fuel cell units 40, 42, 44 by the low-pressure conduits 74, 76 and if the isolation valves 62, 64, 66 are open. Referring to FIGS. 3, 6 and 14, each of the first low pressure conduits 74 can be connected to and extend from a respective one of the outlets 138 and a respective one of the isolation valves 62, 64, 66. Each of the second low-pressure lines 76 can be connected to and extend from a respective one of the isolation valves 62, 64, 66 and a respective one of the fuel cell units 40, 42, 44. The fuel cell units 40, 42, 44 are omitted from FIG. 6 for clarity and simplicity of the drawing and are shown schematically in FIGS. 3 and 12.

Each of the isolation valves 62, 64, 66 can be spaced away from the support tower 114. The isolation valves 62, 64, 66 can be adjacent to each other along the transverse direction T of the vehicle 1, with the second isolation valve 64 between the first isolation valve 62 and the third isolation valve 66. The second isolation valve 64 can be elevated in the vertical direction V of the vehicle 1 along the vertical direction V as compared to the other isolation valves 62, 66. Each of the second low-pressure conduits 76 can have an appropriate shape and length to extend from and between the respective one of the outlets 138 and the respective one of the isolation valves 62, 64, 66.

The first and third fuel cells 40, 44 can be arranged adjacent to each other at the same elevation in the vertical direction V of the vehicle 1 and aligned with each other in the transverse direction T of the vehicle. The second fuel cell 46 can spaced above the first and third fuel cells 40, 44 in the vertical direction V and centered over the first and third fuel cells 40, 44 in the transverse direction T. Each of the second low-pressure conduits 76 can have an appropriate shape and length to extend from and between the respective one of the isolation valves 62, 64, 66 and the respective one of the fuel cell units 40, 42, 44. The lengths and shapes of the each of the low-pressure conduits 74, 76 can be determined based on a desired pathway between the respective one of the outlets 138 and the respective one of the fuel cell units 40, 42, 44 that can minimize pressure losses and avoid other components of the system 36 and the FCS 22.

Referring to FIGS. 6 and 14, the system 36 can include a plurality of fuel cell unit interfaces 172. Each of the fuel cell unit interfaces 172 can include structures that are the same as or similar to each other but different in length and/or shape.

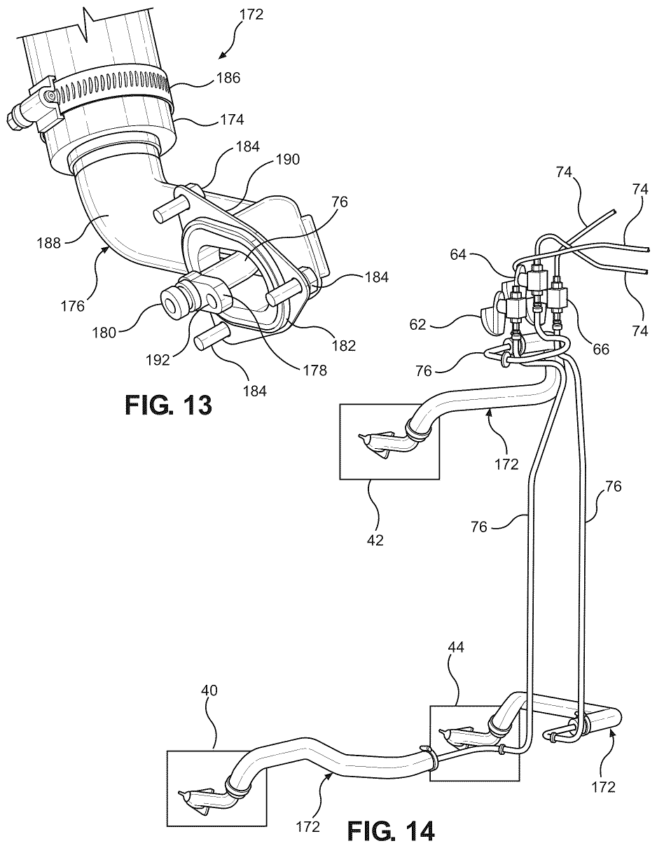

Referring to FIG. 13, each of the fuel cell unit interfaces 172 can include a fume conduit 174, an adapter 176, an alignment flange 178, a fitting 180, an O-ring 182, a plurality of fasteners 184 and a hose clamp 186. A respective one of the second low-pressure conduits 76 can extend through the fume conduit 174 and the adapter 176, with a first portion of the second low-pressure conduit 76 exposed between the respective one of the isolation valves 62, 64, 66 and the fume conduit 174. A second portion of the second low-pressure conduit 76 can protrude out of the adapter 176 and extend into a space in the respective one of the fuel cell units 40, 42, 44. The adapter 176 can close the space and the O-ring 182 can seal the space.

The fuel cell compartment 26 can be hermetically sealed from the remainder of the main housing 12. That is, the main housing 12 can include a wall that isolates the fuel cell compartment 26 from the hydrogen compartment 30. The fume conduit 174 can extend from inside the hydrogen compartment 30, through the wall, and into the fuel cell compartment 26 and can hermitically seal an opening in the wall through which the fume conduit 174 extends. The fume conduit 174 can prevent or limit leakage of gases from the respective one of the fuel cells units 40, 42, 44 out of the fuel cell compartment 26. The fume conduit 174 can include a first open end and a second open end. The first exposed portion of the respective one of the second low-pressure conduits 76 can exit through the seal at the second open end.

The adapter 176 can extend inside of the first open end of the fume conduit 174 and the second open end of the fume conduit 174 can be located between the first open end and the respective one of the isolation valves 62, 64, 66. The hose clamp 186 can connect the fume conduit 174 to the adapter 176 and clamp the inner surface of the fume conduit 174 against an outer surface of the adapter 176 to form a hermitic seal.

The adapter 176 can include a hollow body 188 and an adapter flange 190. The hollow body 188 can extend into of the fume conduit 174 and the hose clamp 186 can overlap the portion of the hollow body 188 that is inside of the fume conduit 174. The flange 190 can surround an opening at an end of the hollow body 188. The O-ring 182 can be mounted onto the flange 190 and surround the opening in the hollow body 188. The low-pressure conduit 76 can extend through the hollow body 188 and exit the adapter 176 via the opening.

The alignment flange 178 and the fitting 180 can be mounted onto the end of the low-pressure conduit 76 that is in the housing space of the respective one of the fuel cell units 42, 44, 46. The alignment flange 178 can include an alignment opening 192 that is configured to mate with a corresponding projection on the respective one of the fuel cell units 40, 42, 44. The fitting 180 can be any appropriate structure that is compatible with the corresponding mating structure of the respective one of the fuel cell units 40, 42, 44.

Each of the fasteners 184 can extend through the adapter flange 190 and into or through a corresponding hole of the respective one of the fuel cell units 40, 42, 44. Each of the fasteners 184 can be any appropriate structure such as, but not limited to, a threaded bolt, a thread bolt and nut, a rivet, a clamp, or a clip.

Referring to FIGS. 3, 6, 7 and 12, the secondary port 60 can be configured to be connected to an external source of hydrogen gas that is separate from the HSS 24 and separate from the vehicle 1. Thus, the FCS 22 of the vehicle 1 can be operated as a stationary electric generator without depleting the hydrogen gas stored in the HSS 24. The secondary port 60 can be any appropriate port that is compatible with a conduit of the external source of hydrogen gas and is compatible with the pressure(s) and flow rate(s) of the external source of hydrogen gas. The secondary port 60 can also be configured to defuel the tanks 32, 34 into an external storage vessel that is separate from the vehicle 1.

The system 36 can include a secondary valve 168 that is in fluid communication with the secondary port 60 and the secondary conduit 80. The secondary valve 168 can selectively open and close fluid communication between the system manifold 46 and the secondary port 60. The secondary valve 168 can include a manual handle that permits a user to manually open and close the secondary valve 168. The handle is shown in solid lines in the closed position and in opened position in phantom in FIGS. 6, 7 and 12. The secondary valve 168 and the secondary port 60 can be integrated into a common housing and the manual handle can be rotatably supported on the common housing as shown in phantom in FIGS. 7 and 12.

Referring to FIGS. 6, 7, 10 and 11, the system 36 can include a plurality of vent conduits that are shown in phantom. These vent conduits can carry hydrogen gas that has been vented by the tanks 32, 34 or a respective one of the pressure regulators 48, 50, 52 to any appropriate location on the vehicle 1.

Referring to FIG. 4, the system 36 can include a control system 194 that can monitor and/or cause certain operations of the system 36. The control system 194 can include the controller 170, a plurality of sensors 110, 112, 196, 198, a plurality of actuators 200, a switch 202 and a display 204.

The controller 170 can be a processor-based controller that is configured with hardware and/or software to execute predetermined instructions that can permit the controller 170 to monitor and cause certain operations of the system 36. The controller 170 can also be referred to as an electronic control unit (ECU), a computer, a microcomputer, a microprocessor, or a central processing unit (CPU). The controller 170 can include or be in electronic communication with a memory device such as, but not limited to, a ROM, a RAM, or an external storage device.

The controller 170 can be in electrical communication with each of the sensors 110, 112, 196, 198, the actuators 200, the switch 202, the display 204 and the electrical connectors 108, 142. The electrical communication can be wired communication or wireless communication or switchable between wired communication and wireless communication.

Each of the plurality of sensors 196 can be a hydrogen sensor that is configured to detect hydrogen gas and output a signal to the controller 170 that includes data that is indicative of a concentration of hydrogen gas within a predetermined space of the system 36. Referring to FIG. 3, a first pair of the hydrogen sensors 196 can be located within the hydrogen compartment 30, each one adjacent to a respective one of the tank support assemblies 38. A second pair of the hydrogen sensors 196 can be mounted on an inner side of the left saddle enclosure 14L and a third pair of the hydrogen sensors 196 can be mounted on an inner side of the right saddle enclosure 14R.

Each of the pressure sensors 198 can be configured to detect a pressure of the hydrogen gas exiting a respective one of the pressure regulators 48, 50, 52 and output to the controller 170 data that is indicative of the exiting gas pressure. Each of the pressure sensors 198 can be mounted on or integrated into a respective one of the pressure regulators 48, 50, 52. Each of the pressure sensors 198 can be in fluid communication with the outlet 138 (FIG. 9) of the pressure regulator. The electrical connector 142 can be electrically connected to the pressure sensor 198.

Each of the actuators 200 can be configured to receive a signal from the controller 170 that cause the actuator 200 to selectively open and close the respective one of the shut-off valves 102, 104, 106 (FIG. 8). Each of the actuators 200 can be mounted on or integral with the system manifold 46. The actuator 200 can be any appropriate electric or electronic device such as, but not limited to a solenoid, a mechanical switch, a relay, or a power transistor or a combination of these structures. Each of the actuators 200 can be in electrical communication with a respected one of the electrical connectors 108.

The switch 202 can be configured to output a signal to the controller 170 that is indicative of the vehicle operator's request to start or stop operation of the FCS 22. The switch 202 can be any appropriate structure such as but not limited to a mechanical switch, knob, dial, or button, or an icon on a touch screen.

The display 204 can be any appropriate device that can present one or more of an image, an icon, a message. The display can include a plurality of individual warning lamps. The display can be a liquid crystal display device without or without a touch screen capability.

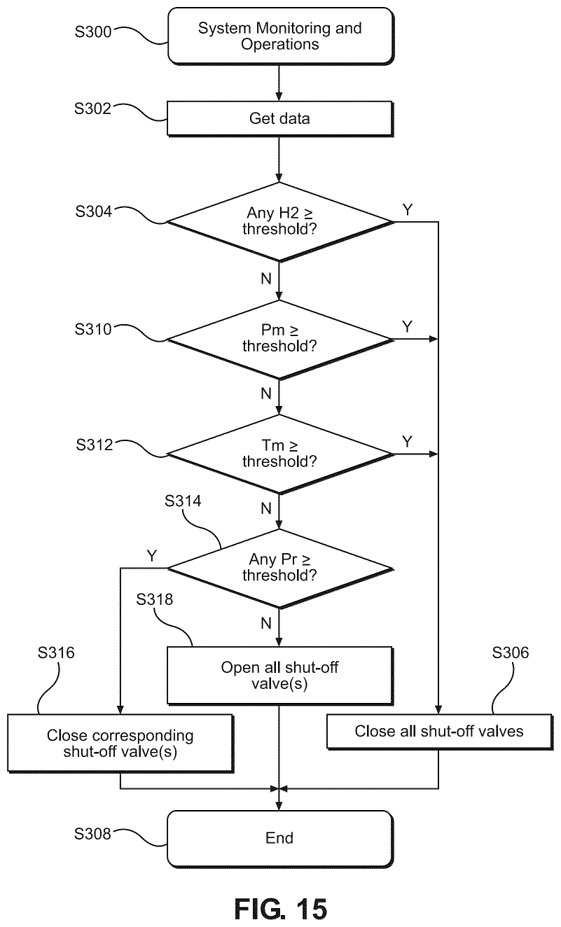

FIG. 15 shows a flowchart for an algorithm that can be executed by the controller 170 so that the controller 170 can monitor and affect certain operations of the system 36. The controller 170 can enter the algorithm at step S300 in response to an input to the switch 202 by a user of the vehicle 1. From step S300, the controller 170 can proceed to step S302.

At step S302, the controller 170 can be configured to obtain the gas concentration signals from the hydrogen sensors 196, the pressure signals from the pressure sensors 110, 198 and the temperature signal from the temperature sensor 112. The controller 170 can be configured to process these signals in real-time, continuously or at predetermined intervals. The controller 170 can be configured to extract a respective concentration value H2 from each of the signals received from the hydrogen sensors 196, a pressure manifold value Pm from the pressure signal received from the pressure sensor 110, a regulator pressure value Pr from the pressure signal received from each of the pressure sensors 198, and a manifold temperature value Tm from the temperature signal received from the temperature sensor 112. From step S302, the controller 170 can be configured to proceed to step S304.

At step S304, the controller 170 can be configured to check whether the concentration of hydrogen gas in any of the hydrogen compartment 30 and the saddle enclosures 14L, 14R exceeds a predetermined concentration threshold. The predetermined concentration threshold can correspond to a concentration value that is indicative of an undesirable leak in one of the hydrogen storage tanks 32, 34 and/or in one of the high-pressure conduits 68, 70. The controller 170 can be configured to proceed to step S306 if the controller 170 determines that any one of the concentration values H2 is equal to or greater than the predetermined concentration threshold.

At step S306, the controller 170 can be configured to de-energize each of the actuators 200. As a result, the valve mechanism in each of the normally closed shut-off valves 102, 104, 106 can close and the flow of hydrogen through the system manifold 46 can be stopped. From step S306, the controller 170 can be configured to proceed to step S308.

At step S308, the controller 170 can be configured to exit the system monitoring and operations algorithm.

Returning to step S304, if the controller 170 determines that all of the concentration values H2 are less than the predetermined concentration threshold, the controller 170 can be configured to proceed to step S310.

At step S310, the controller 170 can be configured to compare the manifold pressure value Pm to a predetermined manifold threshold. The predetermined manifold threshold can be a value that indicates an undesirable operation of the system manifold 46 or an undesirable pressure of the hydrogen entering and/or leaving the system manifold 46. If the controller 170 determines that the manifold pressure value Pm is greater than or equal to the predetermined manifold threshold, then the controller 170 can be configured to proceed to step S306 and execute steps S306 and S308 as described above. If the controller 170 determines that the manifold pressure value Pm is less than the predetermined manifold threshold, the controller 170 can be configured to proceed to step S312.

At step S312, the controller 170 can be configured to compare the manifold temperature value Tm to a predetermined temperature threshold. The predetermined temperature threshold can be a value that indicates an undesirable operation of the system manifold 46 or an undesirable temperature of the hydrogen entering and/or leaving the system manifold 46. If the controller 170 determines that the manifold temperature value Tm is greater than or equal to the predetermined temperature threshold, then the controller 170 can be configured to proceed to step 306 and execute steps 306 and 308 as described above. If the controller 170 determines that the manifold temperature value Tm is less than the predetermined temperature threshold, the controller 170 can be configured to proceed to step S314.

At step S314, the controller 170 can be configured to compare each of the regulator pressure values Pr for each of the pressure regulators 48, 50, 52 to a predetermined regulator threshold. The predetermined regulator threshold can be a value that indicates an undesirable operation of any of the pressure regulators 48, 50, 52 or an undesirable pressure of the hydrogen entering and/or leaving the pressure regulators 48, 50, 52. If the controller 170 determines that any one of the regulator pressure values PR is greater than or equal to the predetermined regulator threshold, then the controller 170 can be configured to proceed to step S316.

At step S316, the controller 170 can be configured to cause the respective one(s) of the actuator 200 to close the respective one(s) of the shut-off valves 102, 104, 106. For example, if the regulator pressure value Pr for the first pressure regulator 48 is greater than or equal to the predetermined regulator threshold, and the regulator pressure value Pr for each of the second pressure regulator 50 and the third pressure regulator 52 are less than the predetermined regulator threshold, then the controller 170 can cause the first shut-off valve 48 to close, or remain closed, and the second and third shut-off valves 50, 52 to open, or remain open.

Returning to step S314, if the controller 170 determines that the all of the regulator pressure values Pr are less than the predetermined temperature threshold, then the controller 170 can be configured to proceed to step S318.

At step S318, the controller 170 can be configured to cause all of the actuators 200 to open, or keep open, the respective one of the shut-off valves 48, 50, 52.

The controller 170 can be configured to proceed from each of steps S316 and S318 to step S308 and exit the system monitoring and operations algorithm.

Thus, the control system 194 can perform fully automated monitoring and operations of the system 36.

In summary, the system 36 can provide a simple and central distribution of hydrogen gas to and from the HSS 24 and to the FCS 22. The system 36 can occupy a minimum volume of the vehicle 1 by locating at least a portion of the system 36 in a space that is between a pair of the vertical tanks 32 and supporting this portion of the system on the support tower 114. The system 36 can be capable of supplying hydrogen to any one or combination of the fuel cell units 40, 42, 44. All of the hydrogen entering the system 36 through the inlet port 54 and all of the hydrogen flowing to the fuel cell units 40, 42, 44 can flow through the system manifold 46, thus simplifying the system 36. Mounting the system manifold 46, the pressure regulators 48, 50, 52 and the second manifolds 150 on the support tower 114 with the associated conduits 68, 74, 164, 166 attached can simplify assembly onto and disassembly from the vehicle 1 by allowing these components to be installed/removed as a single unit. The isolation valves 62, 64, 66 can make it easy to isolate any of the fuel cell units 40, 42, 44 from the system 36 for maintenance or replacement. The isolation valves 62, 64, 66 and the shut-off valves 102, 104, 106 can also permit one or a pair of the fuel cell units 40, 42, 44 to be shut down while permitting continued operation of the vehicle 1. The flexible conduits 84, 130 can move and/or elastically deform in response to the expansion and contraction of the tanks 32, 34 to minimize stress in other components of the system 36 that could be caused by the expansion and contraction.

While certain embodiments of the invention are described above, it should be understood that the invention can be embodied and configured in many different ways without departing from the spirit and scope of the invention.

The electric vehicle 1 is described in the context of a commercial transport vehicle. However, the disclosed main power system 10 can be used with any electric vehicle that is configured for travel along any one or combination of improved, unimproved, and unmarked paths, as well as via waterways and airways. For example, embodiments are intended to include or otherwise cover any type of vehicle, including a passenger car, a minivan, a sport-utility vehicle, a crossover vehicle, a bus, an off-highway vehicle, a construction vehicle, a locomotive, a boat, a plane, spacecraft, a truck without a trailer, etc.

The electric vehicle 1 described above can include three fuel cell units 40, 42, 44. However, alternate embodiments can include less than three or more than three fuel cell units 40, 42, 44. The number of pressure regulators 48, 50, 52 can be same as the number of fuel cell units 40, 42, 44. The number of isolation valves 62, 64, 66 can also be same as the number of fuel cell units 40, 42, 44.

The electric vehicle 1 described above can include eight hydrogen storage tanks 32, 34. However, alternate embodiments can include less than eight or more than eight hydrogen storage tanks. Alternate embodiments can omit any one or any subcombination of the hydrogen storage tanks 32, 34 as long as the electric vehicle 1 includes at least two storage tanks.

Instead of a handle, each of the isolation valves 62, 64, 66 can be electrically actuated to selectively open and close fluid communication to the respective one of the fuel cell units 40, 42, 44. The control system 194 can include an interface such as, but not limited to, a touch screen, a switch, a dial, a knob, a button that causes the desired opened state or closed state in response to the operator's request via the interface.

Instead of the controller 170 causing each of the actuators 200 to selectively open and close the respective one of the shut-off valves 102, 104, 106, alternate embodiments can include the controller 170 configured to present a message on the display 204 that requests an input from the operator of the vehicle 1 that is indicative of a request to open or close any one or any combination of the shut-off valves 102, 104, 106. The operator can input the request via the display 204 in exemplary embodiments in which the display 204 is a touch screen display. In alternate embodiments, the control system 194 can include one or a plurality of switch(es), dial(s), knob(s), button(s) that are configured to send the operator's request to the controller 170. In alternate embodiments, the actuators 200 can be configured to be actuated manually instead of by the controller 170 and the controller 170 can be configured to merely process the signals from the sensors 110, 112, 196, 198 and present an appropriate message on the display 204.

In alternate embodiments, each of the regulator brackets 124 can be connected to the respective one of the pressure regulators 48, 50, 52 by any appropriate structure such as, but not limited to, welds, adhesive, rivets, clamps, of clips.

In alternate embodiments, any of the brackets 122, 124, 160 can be omitted and the corresponding first manifold 46, pressure regulators 48, 50, 52 and second manifolds 150 can be secured directly to the support tower 114.

In alternate embodiments, each of the trunk brackets 160 can be connected to the respective one of the second manifolds by any appropriate structure such as, but not limited to, welds, adhesive, rivets, clamps, of clips.

Instead of under the saddle enclosures 14L, 14R, the horizontal tanks 34 could be oriented vertically and located in the hydrogen compartment 30 with the vertical tanks 32.

The FCS 22 can include any currently known or future-developed fuel cell structure(s). Alternate embodiments of the fuel cell can include any appropriate chemical reaction(s) that produces electrons that can be stored in a battery, capacitor or any other known or future developed electron storage device.

The centralized hydrogen distribution system 36 can include multiple tanks and hydrogen fuel that are centrally distributed at high pressure to three fuel cells.

Each fuel cell unit 40, 42, 44 can be isolated for service individually. Hydrogen can be distributed within the system at high pressure, and tank connections can be made with flexible lines to allow for the hydrogen storage tanks to expand or contract without exerting undue stress on hydrogen plumbing.

The system can include a secondary fueling and defueling port to facilitate FCS power generation without on-board storage, defuel the HSS 24 without requiring FCS fuel injection, and pressurize the HSS 24.

The system can integrate the gas handling units 48, 50, 52 and meet pressure-drop requirements for FCS 22 inlet pressure. The system 36 can adapt to the FCS 22 conduit inlet hose connection.

In accordance with another embodiment of a centralized hydrogen distribution system 36, the system 36 can feature 80 kg of hydrogen fuel that is centrally distributed at high pressure to three fuel cells. The distribution system 36 allows for even flow across eight 10 kg capacity hydrogen storage tanks. Each fuel cell unit 40, 42, 44 can be isolated for serviced individually. Hydrogen can be distributed within the system 36 at high pressure (<875 bar) and can sustain fueling at 60 g/sec. Tank connections can be made with flexible lines to allow for hydrogen storage tanks to expand or contract without exerting undue stress on hydrogen plumbing. Fueling can be performed at communications and non-communications fueling stations. The system 36 can be designed to comply with various regulations, including ASME B31, HGV2, HGV3.1, SAE J2600, SAE J2578, and SAE J2579. The system 36 can be capable of purging fill lines from vehicle sides to fill stations that cannot purge fill lines. The system 36 can include a secondary fueling and defueling port to facilitate FCS 22 power generation without on-board storage, defuel H2 storage systems without requiring FCS 22 fuel injection, and pressurize the HSS 24 without the need for a SAE J2600 compliant nozzle. The system 36 can integrate gas handling units and can meet pressure-drop requirements for the inlet pressure of the fuel cell units 40, 42, 44. The system 36 can also be configured to adapt to the conduit inlet hose connection on each of the fuel cell units 40, 42, 44.

In another embodiment, each hydrogen storage tank 32, 34 can include a pressure relief valve (e.g., tank pressure relief device) as shown in schematic form in FIG. 3 at one end of each of the tanks 32, 34, and can include an on-tank valve at an opposite end of each of the tanks 32,34

Instead of two electric motors 8, 9, alternate embodiments of the electric vehicle 1 can include one electric motor or more than two electric motors. Each electric motor can be directly coupled to a respective wheel or pair of wheels. In alternate, embodiments, a geartrain can transfer the output by the electric motor(s) to the respective wheel(s).

An alternate embodiment of the centralized hydrogen distribution system 36 can include supply lines are centrally located between two sets of three hydrogen storage tanks wherein the lines, valves, manifolds, and connections are secured to a support tower that is centrally located between the two sets of three hydrogen storage tanks. Also, the hydrogen distribution system includes the feature that each fuel cell unit 40, 42, 44 can be isolated for service individually, and can be a system having secondary fueling and defueling ports to facilitate FCS 22 power generation without on-board storage.

Alternate embodiments of the algorithm of FIG. 15 can include the steps S304, S310 and S312 performed in any order relative to each other.

What is claimed is:

1. A centralized hydrogen distribution system for an electric vehicle, the electric vehicle including a plurality of hydrogen storage tanks and at least one fuel cell unit, the centralized hydrogen distribution system being configured to supply hydrogen from the hydrogen storage tanks to the fuel cell unit, the centralized hydrogen distribution system comprising:
a support tower configured to be centrally located among the hydrogen storage tanks, the support tower including a main trunk and a connection structure, the connecting structure is configured to connect the support tower to the electric vehicle;
a first manifold secured to the support tower and configured to be in fluid communication with each of the hydrogen storage tanks; and
a pressure regulator secured to the support tower, in fluid communication with the first manifold, configured to be in fluid communication with the fuel cell unit, and configured to reduce a pressure of hydrogen flowing through the pressure regulator.

2. The centralized hydrogen distribution system of claim 1, further comprising:
a plurality of flexible conduits, each of the conduits includes a first end configured to be connected to and be in fluid communication with a respective one of the hydrogen storage tanks and a second end connected to and in fluid communication with the first manifold, each of the flexible conduits is configured to move relative to the first manifold if the respective one of the hydrogen storage tanks expands or contracts.

3. The centralized hydrogen distribution system of claim 1, further comprising:
an inlet port in fluid communication with the first manifold and configured to be connected to an infrastructure storage tank for filling the hydrogen storage tanks;
a secondary port in fluid communication with the first manifold and configured to be connected to the infrastructure storage tank or a different source of hydrogen that is separate from the electric vehicle; and
a secondary valve that selectively opens and closes fluid communication between the secondary port and the first manifold.

4. The centralized hydrogen distribution system of claim 1, further comprising:
a secondary port in fluid communication with the first manifold and configured to supply hydrogen to the hydrogen storage tanks via the first manifold and defuel the hydrogen storage tanks into a vessel that is external to the electric vehicle.

5. The centralized hydrogen distribution system of claim 1, wherein the at least one fuel cell unit includes a plurality of fuel cell units, and the system further comprising:
an isolation valve configured to isolate at least one of the plurality of fuel cell units such that each of the fuel cell units is individually serviceable while a remainder of the fuel cell units remains operably connected to the first manifold.

6. The centralized hydrogen distribution system of claim 5, wherein
the support tower includes:
a first bracket mounted onto the main trunk;
a second bracket mounted onto the main trunk;
a second manifold mounted on the second bracket and in fluid communication with each of the first manifold and the pressure regulator; and
a third bracket mounted on the main trunk,
the first manifold is mounted onto the first bracket and the pressure regulator is mounted on the third bracket,
the main trunk is a hollow, elongated tube, and
the connection structure is one of flange and a bracket that protrudes from the main trunk.

7. The centralized hydrogen distribution system of claim 6, wherein
the pressure regulator includes a pair of high-pressure inlets and a low pressure outlet, and
the second manifold includes:
an inlet in fluid communication with the first manifold; and
a pair of manifold outlets, each of the manifold outlets is in fluid communication with a respective one of the high-pressure inlets.

8. The centralized hydrogen distribution system of claim 1, further comprising:
a low-pressure conduit in fluid communication with the first manifold and configured to be connected to and in fluid communication with the fuel cell unit; and
a fuel cell unit interface including:
a fume conduit, the low-pressure conduit extends through the fume conduit;
an adapter connected to and extending from the fume conduit, wherein
the low-pressure conduit extends through the adapter, and the adapter is configured to be mounted onto the fuel cell unit.

9. The centralized hydrogen distribution system of claim 8, wherein the adapter includes:
a hollow body that extends into the fume conduit; and
a mounting flange that is configured to be mounted onto the fuel cell unit and includes an O-ring that is configured to form a fluid seal between the mounting flange and the fuel cell unit.

10. The centralized hydrogen distribution system of claim 8, further comprising:
an isolation valve spaced away from each of the support tower and the fume conduit, the isolation valve is in fluid communication with each of the pressure regulator and the low-pressure conduit, the isolation valve is configured to selectively open and close fluid communication through the low-pressure conduit, and the isolation valve includes a manual input that is selectable to selectively open and close fluid communication through the isolation valve.

11. The centralized hydrogen distribution system of claim 1, further comprising:
an inlet port spaced away from the support tower, the inlet port is configured to connect to an infrastructure storage tank for filling the hydrogen storage tanks;
a fill line connected to and in fluid communication with each of the inlet port and the first manifold;
a check valve in the fill line and configured to permit fluid flow through the fill line from the inlet port to the first manifold and prevent fluid flow through the fill line from the first manifold to the inlet port; and
a purge solenoid in fluid communication with the fill line and configured to selectively vent fluid in the supply line that is between the check valve and the inlet port.

12. A centralized hydrogen distribution system for an electric vehicle, the electric vehicle including a plurality of hydrogen storage tanks and a plurality of fuel cells, the centralized hydrogen distribution system being configured to supply hydrogen from each of the hydrogen storage tanks to each of the fuel cells, the centralized hydrogen distribution system comprising:
a support tower configured to be centrally located among the hydrogen storage tanks, the support tower including a connecting structure configured to connect the support tower to the electric vehicle;
a manifold secured to the support tower and configured to be in fluid communication with each of the hydrogen storage tanks; and
a plurality of pressure regulators secured to the support tower and in fluid communication with the manifold, each of the pressure regulars is configured to be in fluid communication with a respective one of the fuel cells and configured to reduce a pressure of hydrogen flowing through the pressure regulator.

13. The centralized hydrogen distribution system of claim 12, wherein the pressure regulators are arranged in a column on the main trunk and spaced away from each other.

14. The centralized hydrogen distribution system of claim 12, further comprising:
a plurality of isolation valves, each of the isolation valves is in fluid communication with a respective one of the pressure regulators, and each of the isolation valves includes an outlet that is configured to be in fluid communication with a respective one of the fuel cells.

15. The centralized hydrogen distribution system of claim 12, further comprising:
an inlet port configured to connect to an infrastructure storage tank for filling the hydrogen storage tanks;
a fill line connected to and in fluid communication with each of the inlet port and the manifold;
a check valve in the fill line and configured to permit fluid flow through the fill line from the inlet port to the manifold and prevent fluid flow through the fill line from the manifold to the inlet port; and
a purge solenoid in fluid communication with the supply line and configured to selectively vent fluid in the fill line that is between the check valve and the inlet port.

16. A centralized hydrogen distribution system for an electric vehicle, the electric vehicle including a plurality of hydrogen storage tanks and a plurality of fuel cells, the centralized hydrogen distribution system being configured to supply hydrogen from each of the hydrogen storage tanks to each of the fuel cells, the centralized hydrogen distribution system comprising:
a support tower configured to be centrally located among the hydrogen storage tanks;
a manifold secured to the support tower and configured to be in fluid communication with each of the hydrogen storage tanks, the manifold includes a plurality of shut-off valves, each of the shut-off valve is configured to be in selective fluid communication with a respective one of the fuel cells;
a plurality of pressure regulators secured to the support tower and in fluid communication with the manifold, each of the pressure regulars is configured to be in fluid communication with a respective one of the fuel cells and configured to reduce a pressure of hydrogen flowing through the pressure regulator, each of the pressure regulators includes a first pressure sensor that is in fluid communication with a respective one of the pressure regulators and configured to output a first pressure signal that is indicative of a pressure inside the respective one of the pressure regulators; and
a controller in electrical communication with each of the pressure regulators and configured to cause the shut-off valves to selectively and independently open and close fluid flow through the shut-off valves based on the first pressure signal received from at least one of the first pressure sensors.

17. The centralized hydrogen distribution system according to claim 16, further comprising:
a second pressure sensor mounted on and in fluid communication with the manifold and configured to output a second pressure signal that is indicative of a pressure inside the manifold; and
temperature sensor adjacent the manifold and in thermal communication with fluid flowing through the manifold, the temperature sensor is configured to output a temperature signal that is indicative of a temperature inside the manifold, wherein
the controller is in electric communication with each of the second pressure sensor and the temperature sensor, and the controller is configured to cause the shut-off valves to selectively and independently open and close fluid flow through the shut-off valves based on at least one of the second pressure signal and the temperature signal.

18. An electric vehicle comprising:
the centralized hydrogen distribution system according to claim 16;
a chassis extending in a longitudinal direction and a transverse direction;
a cab mounted on the chassis and extending away from the chassis in a vertical direction;
a fuel cell compartment mounted on the chassis;
a plurality of fuel cell units mounted inside of the fuel cell compartment, each of the fuel cells is in fluid communication with a respective one of the pressure regulators;
a fuel storage compartment mounted on the chassis;
a plurality of first hydrogen gas storage tanks mounted inside of the fuel storage compartment and in fluid communication with the manifold;
a plurality of second hydrogen gas storage tanks mounted in the fuel storage compartment and in fluid communication with the manifold;
a space separating one of the second hydrogen gas storage tanks from one of the first hydrogen storage tanks, wherein
the support tower is located in the space separating the one of the second hydrogen gas storage tanks from the one of the first hydrogen storage tanks.

19. The electric vehicle according to claim 18, further comprising:
a hydrogen gas sensor in at least one of the fuel storage compartment and the fuel cell compartment, wherein
the controller is configured to cause the shut-off valves to selectively open and close fluid flow through the shut-off valves based on a gas signal received from the hydrogen gas sensor.

20. The electric vehicle according to claim 19, further comprising:
a third hydrogen gas storage tank mounted on the chassis at a location that is outside of the fuel storage compartment and in fluid communication with the manifold, a longitudinal axis of the third hydrogen gas storage tank being substantially perpendicular to a longitudinal axis of one of the plurality of first hydrogen gas storage tanks.
